(19) United States
(12) Patent Application Publication
(10) Pub. No.: US 2014/0077056 A1
(43) Pub. Date: Mar. 20, 2014

(54) CLIP MOUNTED HOLDER FOR ARTICLE

(71) Applicant: Krishnan K. Ghosh, Chicago, IL (US)

(72) Inventor: Krishnan K. Ghosh, Chicago, IL (US)

(21) Appl. No.: 13/622,469

(22) Filed: Sep. 19, 2012

(51) Int. Cl. F16M 13/02

(52) U.S. Cl. CPC F16M 13/02
USPC 248/690; 248/231.81; 248/205.1

(57) ABSTRACT

An article holder is disclosed. The article holder includes a mounting clip with a top and bottom member pivotally attached to one another and spring loaded so as to clip mount to a base element. In certain embodiments, the mounting clip includes a groove in a top surface adapted to receive an article such as an electronic tablet device. Thus, the article holder can clip to a base element such as an airplane tray table and hold the article in a viewing position. A second groove oriented in a direction substantially perpendicular to the first groove may be provided for an alternate mode of use. In further embodiments, the groove may be formed by a groove wall in the top member and a lip on a cradle element which projects into the clip.

### BACKGROUND OF THE INVENTION

1. Field of the Invention

The present invention relates to holders for various articles, and more particularly, a clip-mounted holder for generally flat items such as electronic tablets, books, and magazines.

2. Background

There are numerous situations in which it would be desirable to have an article such as an electronic tablet, phone, or other article mounted to a nearby surface so that hands free operation is possible. A number of mounting mechanisms have been proposed, however, none of them address the needs for these items. A need for a device which mounts to an airplane tray table or hook is particularly present in present times when travelers routinely travel with electronic devices which could be mounted conveniently.

While a number of devices have been proposed, they lack various helpful configurations. For example, U.S. Patent Application Publication No. US2009/0060473 filed by Kohte et al. discloses a portable device holder which clamps onto a table. However, the device includes a stem which extends from the clamp, and a holder. The device is cumbersome, and can be used in limited situations and configurations.

U.S. Patent Application Publication No. US2009/0189039 filed by LaBuda discloses another type of holder which clamps to a table top. It also discloses a stem extending from the clamp. Again, it is cumbersome and limited in uses and features.

Furthermore, U.S. Patent Application Publication No. US2010/0078536 filed by Galvin discloses a similar device which clamps to a table top and includes a stem. As with the other devices described, a cumbersome stem is provided, and a limited manner of attachment is provided.

None of these prior devices provide a compact and versatile holder for articles with a number of useful features and different modes of use. Thus, there continues to be a need for a practical, compact, and versatile article holder with multiple modes of use.

### SUMMARY

The present invention is an article holder for holding an article. The article holder includes a mounting clip formed of a top member and a bottom member. Ideally, the top and bottom members are spring loaded with respect to one another and pivotally attached to one another so that the mounting clip is adapted to clip onto a base element such as a table or airplane tray table. However, the top and bottom members may be separate or integral parts of the device, and the device may optionally be form-fitted to fit a base element.

In various embodiments, the top member of the mounting clip includes a groove adapted to receive an article and hold it in a viewing position. Ideally, the groove is positioned substantially parallel to the front edge of the top member. The groove is adapted to receive and hold an article such as an electronic tablet device, or a book or magazine, or any other article which can be held in a viewing position by placing it in a groove.

In certain embodiments, a second groove is disposed on the top surface of the top member at an angle different from that of the first groove. For example, a groove positioned perpendicular with respect to the first groove may be formed. It may criss-cross with the first groove. This allows the holder to be used in different positions. For example, the clip may be mounted to the back side of an airplane tray table and the first, horizontal groove may be used to hold an article at an appropriate viewing angle. The clip could also be mounted on the side edge of the tray table, and the perpendicular groove can be used to hold the article at an appropriate viewing angle.

In further embodiments, the top member of the mounting clip provides a groove wall configured to form one side wall of a groove. A cradle member is provided having a projection which extends into the inside portion of the clip, and a lip extends out of the clip opening and up toward the groove wall to form the other side of the groove. Ideally, the cradle member is configured to be adjusted inward or outward into and out of the clip so that the width of the groove can be adjusted. This allows the groove to be adapted to receive articles of various thicknesses, or, alternatively, to hold the article and different tilts for viewing at different angles. For example, an electronic tablet device, by which is meant any tablet style device such as those currently sold under the brand name IPAD, or a reading device such as a KINDLE device, mobile phone, NOOK, or other electronic device generally shaped or configured in a similar manner, can be tilted to various degrees as to the preference of the user. Articles such as books or magazines can also be suitably held by the article holder of the present invention.

In certain preferred embodiments, the projection of the cradle member includes teeth or projections which interdigitate with similar projections extending from the top member so that they lock together in various adjustable positions. Thus, the cradle member can be moved inward or outward and locked into place within the clip in various positions.

In various embodiments, a lanyard is attached at two points, preferably toward the side edges of the cradle member. The lanyard preferably then passes through a hole in the mounting clip so that it can be hooked onto a hook of some sort from above. In this fashion, the mounting clip can clip to the top portion of an article such as an electronic tablet device, while the cradle member supports a bottom edge of the device. The lanyard can then be supported by a hook, such as the latch which holds an airplane tray table in the closed position, and the article can be held in a viewing position.

In certain embodiments, the mounting clip may have at least one suction cup on the bottom side to further hold the item in a secure position.

In other embodiments, the article holder includes a clip mounted platform which clips onto a tray. A base member mounts to the platform. A lower cradle mounts adjustably to the base member. An upper cradle member works in conjunction with a lanyard and the lower cradle member to support an article such as a tablet device.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a side view of one embodiment of the article holder of the present invention.

FIG. 2 shows a perspective view of one embodiment of the article holder of the present invention holding an article.

FIG. 3 shows a perspective view of one embodiment of the article holder of the present invention holding an article in a different position.

FIG. 4 shows a perspective view of one embodiment of the article holder of the present invention holding an article.

FIG. 5 shows a perspective view of one embodiment of the article holder of the present invention holding an article in a different position.

FIG. 6 shows a perspective view of another embodiment of the article holder of the present invention.

FIG. 7 shows a perspective front view of another embodiment of the article holder of the present invention.

FIG. 8 shows a perspective back view of another embodiment of the article holder of the present invention.

FIG. 9 shows a perspective front view of another embodiment of the article holder of the present invention holding an article.

FIG. 10 shows a perspective back view of another embodiment of the article holder of the present invention holding an article.

FIG. 11 shows a perspective view of another embodiment of the article holder of the present invention.

FIG. 12 shows a perspective view of another embodiment of the article holder of the present invention.

FIG. 13 shows a perspective view of another embodiment of the article holder of the present invention.

FIG. 14 shows a perspective view of another embodiment of the article holder of the present invention.

FIG. 15 shows a perspective view of another embodiment of the article holder of the present invention.

FIG. 16 shows a perspective view of another embodiment of the article holder of the present invention.

FIG. 17 shows an expanded perspective view of another embodiment of the article holder of the present invention.

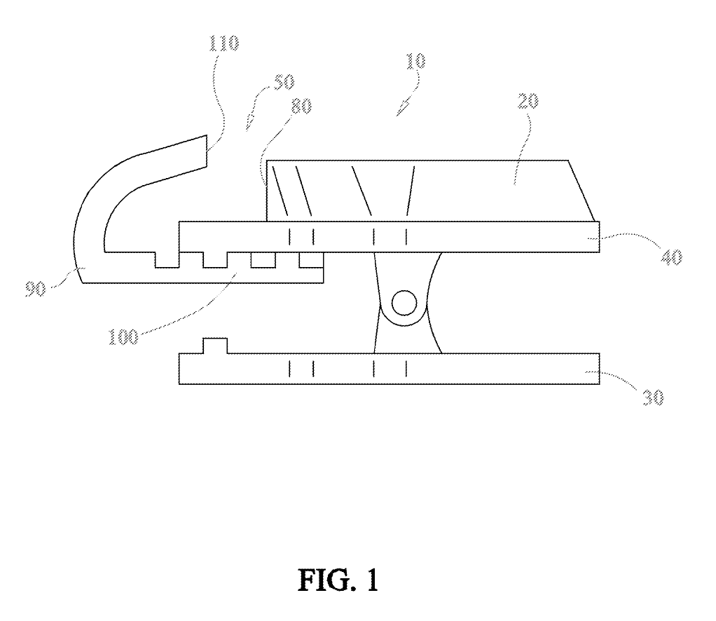

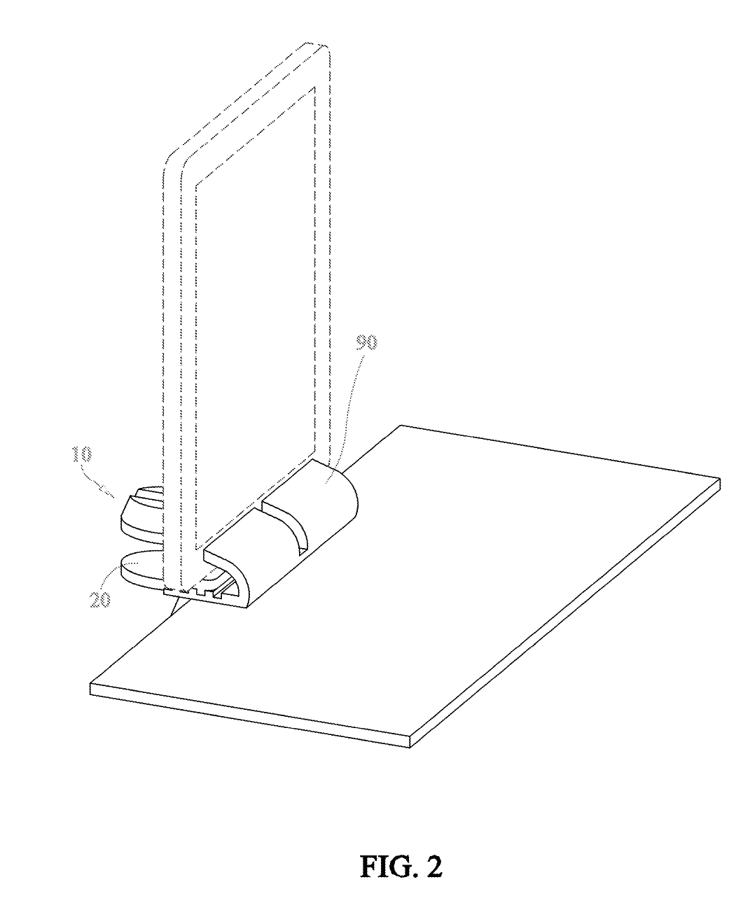

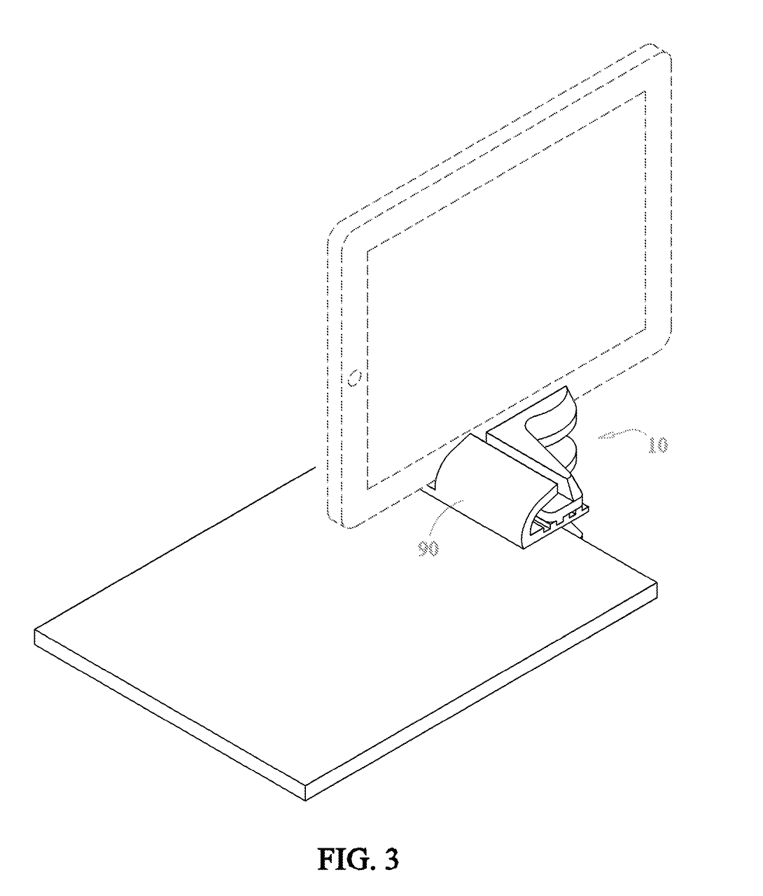

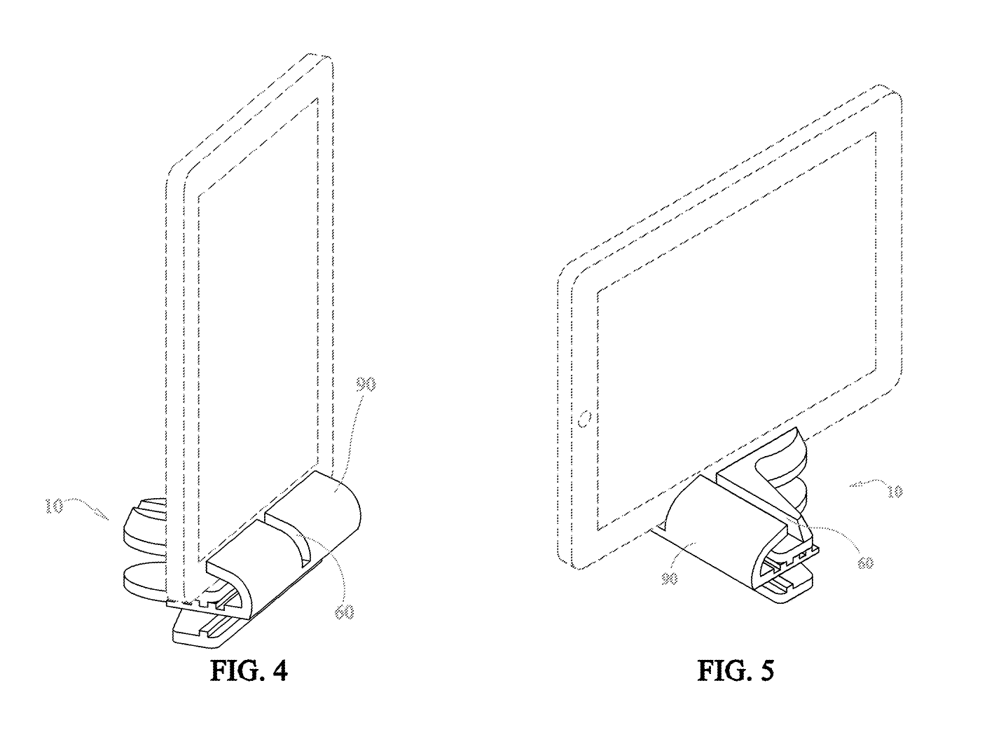

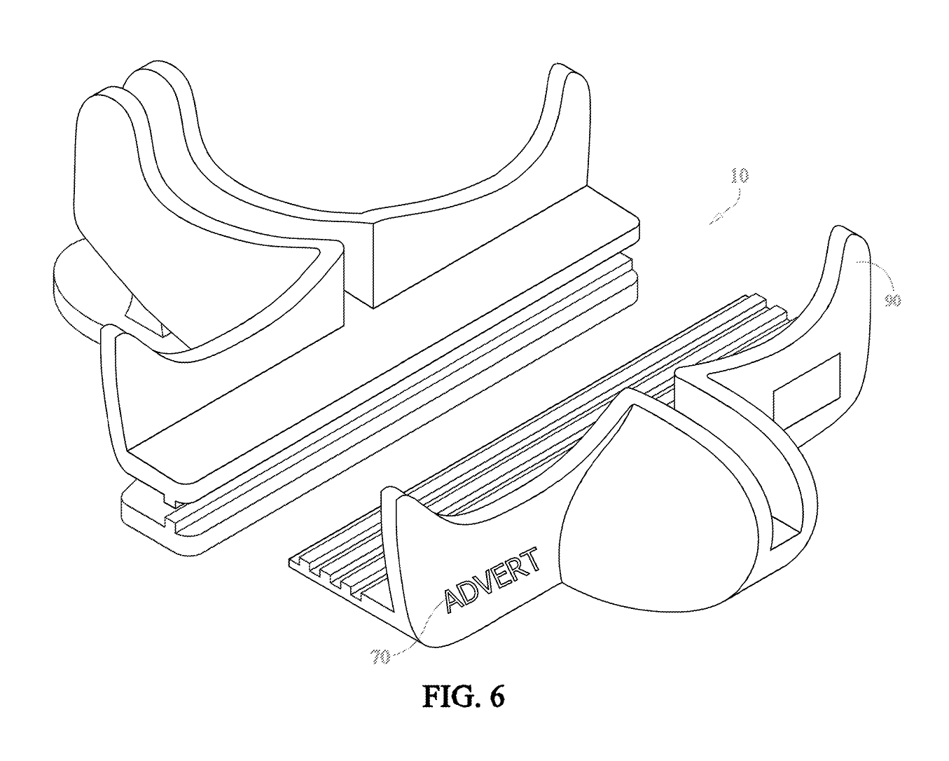

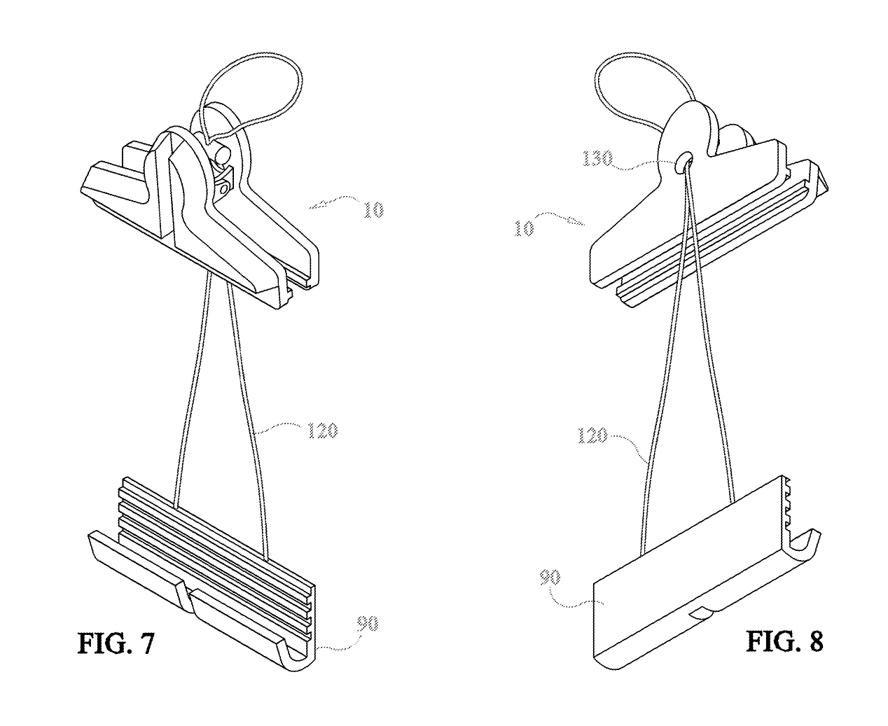

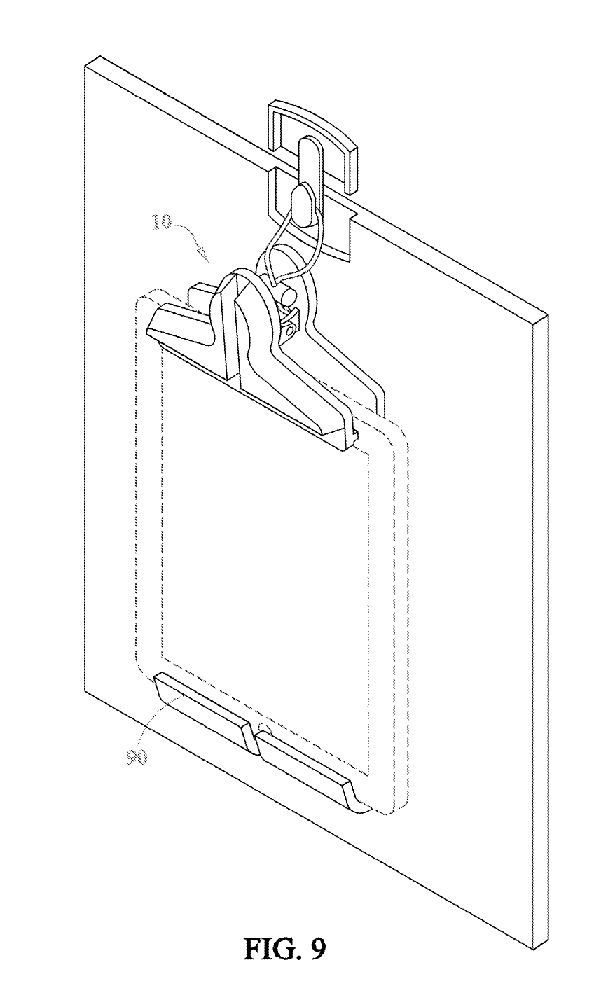

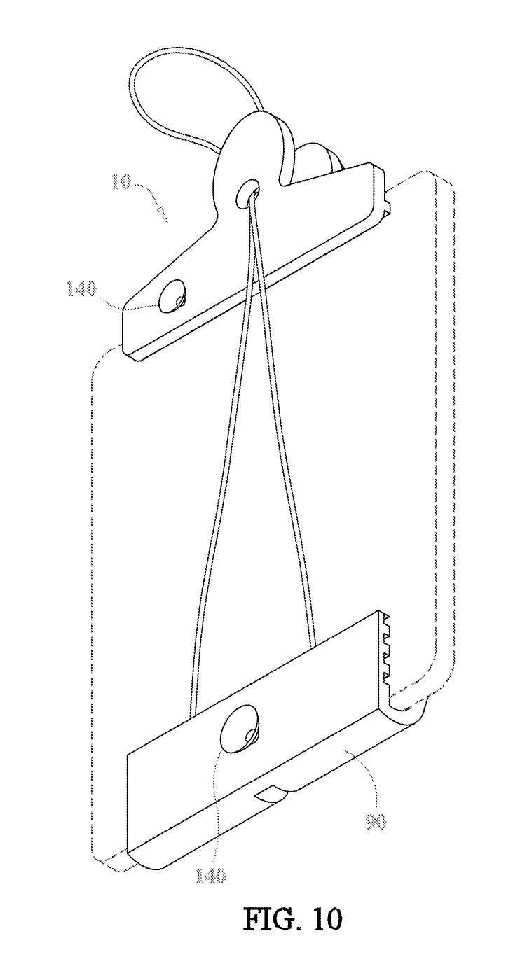

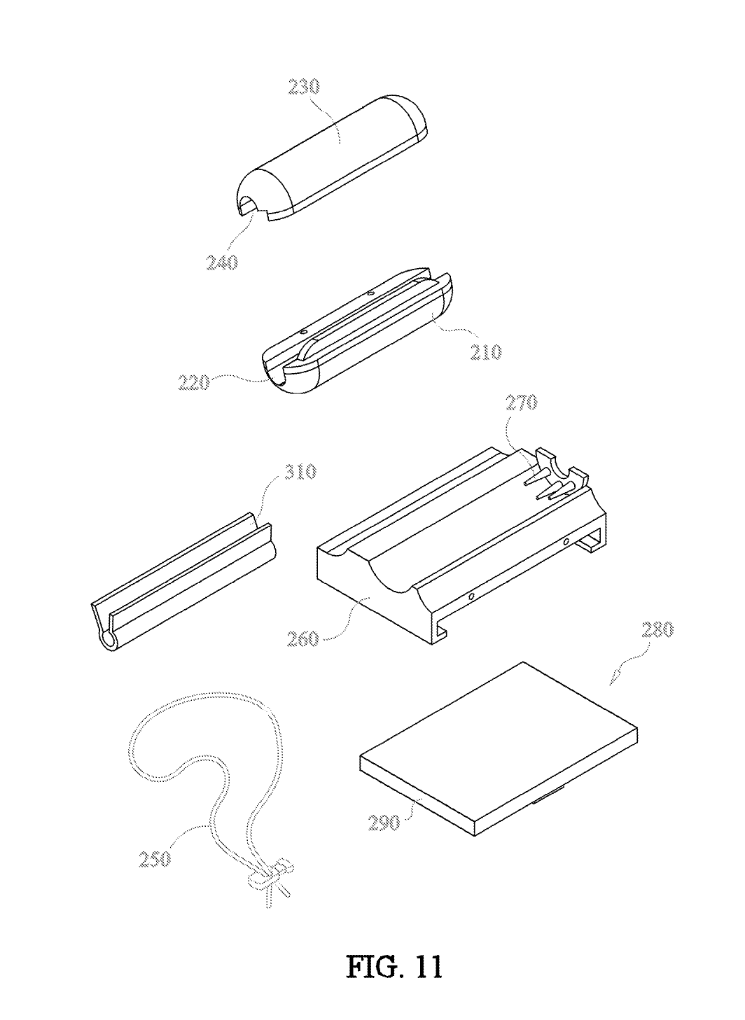

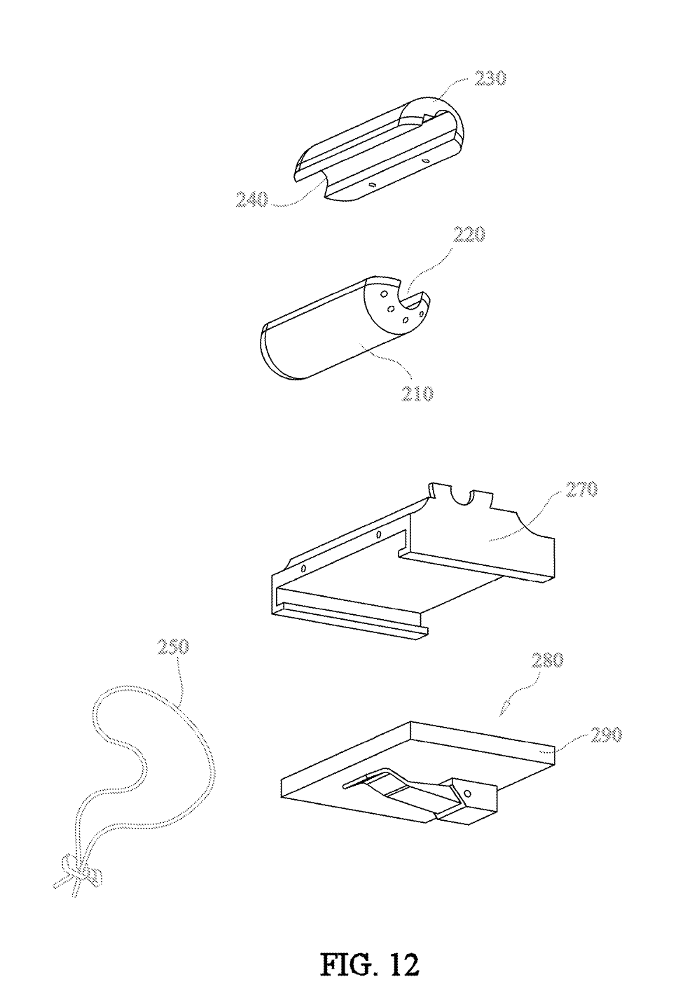

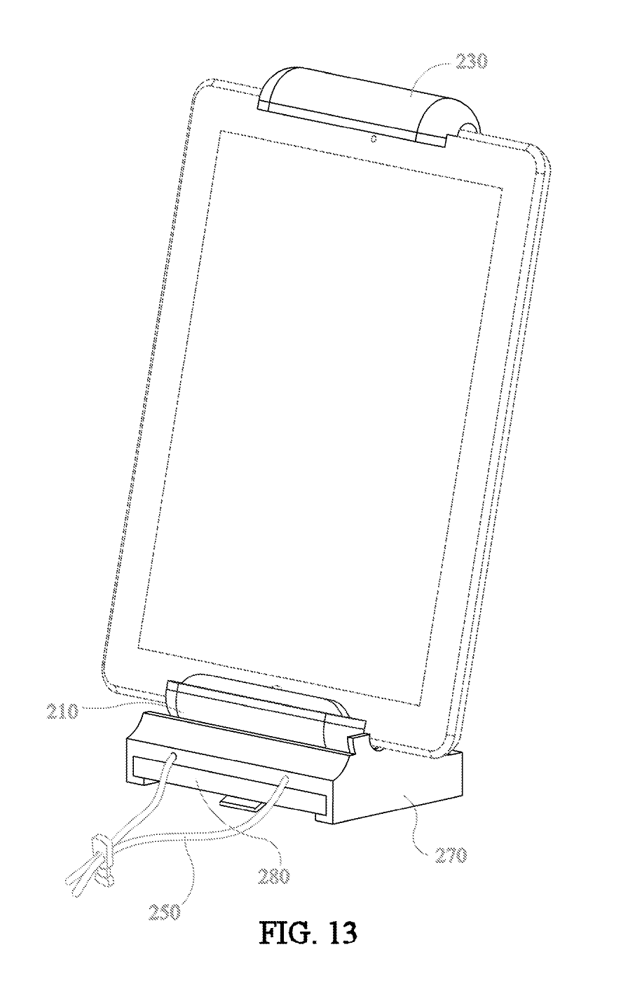

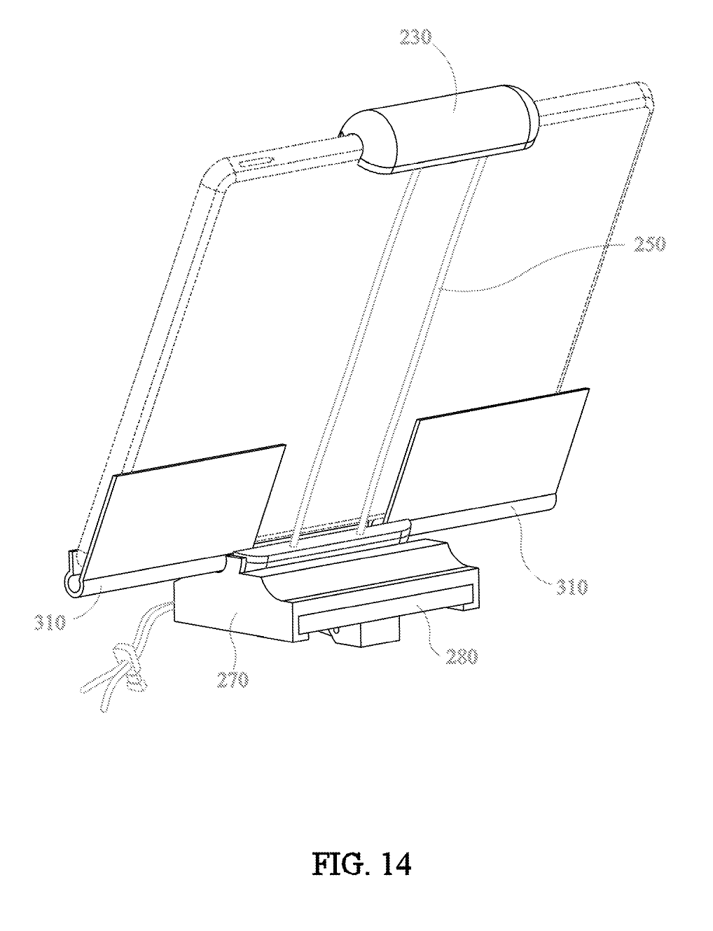

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is an article holder 10 for mounting an article over a base element. The article holder 10 includes a mounting clip 20 having a bottom member 30 and a top member 40 adapted to clip onto a base element. The base element may be a table, an airplane tray table, or any other surface on which one could mount an article. The top member 40 includes a top surface having a first groove 50 therein adapted to receive an article and hold it in a viewable position.

In various embodiments, the top member 40 and bottom member 30 may be pivotally connect to one another and spring loaded with respect to one another, or they may be integral and form fitted. The mounting clip 20 is adapted to adjust to a range of thicknesses of a base member and mount securely thereto.

The first groove 50 is ideally configured in substantially parallel alignment with a front edge of the mounting clip 20. Thus, the mounting clip 20 may be clipped to the back edge of a tray table and the groove 50 will be positioned to hold the article in a suitable viewing position facing the user.

In various embodiments, an optional second groove 60 is provided oriented in a direction different from the first groove 50. Ideally, the second groove 60 is substantially perpendicular to the first groove 50, and may criss-cross the same. Thus, the clip 20 may be mounted to a side edge of a tray table, for example, and the second groove 60 can hold an article in a position in which it faces the user.

In certain embodiments, the mounting clip 20 may be shaped in a promotional shape unrelated to the article holder 10. For example, the mounting clip 20 may generally be in the shape of an airplane. In some embodiments, the mounting clip 20 may have promotional indicia 70 thereon. The indicia 70 may be provided directly on the surface of the mounting clip 20. Alternatively, the indicia 70 may be provided on a removably mounted plate.

In certain preferred embodiments, the article holder 20 has a mounting clip 20 which is adapted to mount to an airplane tray table, and the groove 60 or 70 is adapted to receive an electronic tablet device.

In various other embodiments, the article holder 10 includes a mounting clip 20 having a bottom member 30 and a top member 40 adapted to clip onto a base element, the top member 40 having a top surface having a first groove wall 80 thereon. The holder 10 further includes a cradle element 90 having a bottom projection 100 adapted to fit within a biting opening formed between the bottom member 30 and the top member 40. The cradle element 90 further includes a lip 110 adapted to wrap around a portion of a front edge of the top member. Groove 50 is formed by a gap between the lip 110 and the first groove wall 80 when the cradle element 90, in a first mode of use, is disposed with its bottom projection 100 between the bottom member 30 and the top member 40. In this mode of use, the groove 50 is adapted to receive an article and hold it in a viewing position.

In certain embodiments, the cradle element 90 is adapted to be adjusted between at least two positions resulting in different widths associated with the groove 50 to enable the groove 50 to receive articles of different thicknesses or hold articles at different viewing angles. In certain embodiments, the projection 100 of the cradle element 90 includes a plurality of projections and indentations adapted to interdigitate with a plurality of projections and indentations in a bottom surface of the top member 40 to enable the cradle element 90 to be selectively secured in the at least two positions.

In certain further embodiments, a lanyard 120 is attached to the cradle element 90. Ideally, the lanyard 120 further passes through a hole 130 in the mounting clip 20. The lanyard 120 is preferably adapted to hang from a point above the hole 130, and in a second mode of use, the cradle element 90 is adapted to support a bottom edge of an article while the mounting clip 20 is clipped to a top portion of such an article and the lanyard 120 is mounted over a hook above the mounting clip 20. Thus, an article such as an electronic tablet can be held in a viewing position such as from the latch for a tray table.

Ideally, the lanyard 120 is attached at two points on the cradle element 90, preferably at opposite edges of the cradle element 90. In this fashion, the lanyard 120 is not in the way when the holder 10 is used in the first mode of use.

In certain embodiments, the mounting clip 20 includes a suction cup 140 either on the back of the mounting clip 20 or on the back of the cradle element 90. The suction cup 140 serves to help secure the article when held in a vertical position in the second mode of use.

In various other embodiments, the article holder of the present invention includes a lower cradle member 210 having a groove 220 adapted to support an article at a lower edge of such an article. Optionally, an upper cradle 230 has a groove 240 which is adapted to receive an upper edge of such an article. For example, a tablet device can be held by both the upper cradle member 230 and the lower cradle member 210. A lanyard 250 connects the lower cradle member 210 and the upper cradle member 230.

In certain embodiments, the article holder further includes a base member 260. The base member 260 is adapted to receive the lower cradle member 210 so that they are removably mounted. Optionally, the lower cradle member 210 and the base member 260 are configured to allow the lower cradle member 210 to be adjustable between a plurality of rotation angles. This configuration optionally takes the form of prongs 270 in the base member 260 and receiving holes in the lower cradle member 210. However, any suitable method of mounting the cradle member 210 such that it is adjustable between various rotation angles is contemplated within the scope of the present invention.

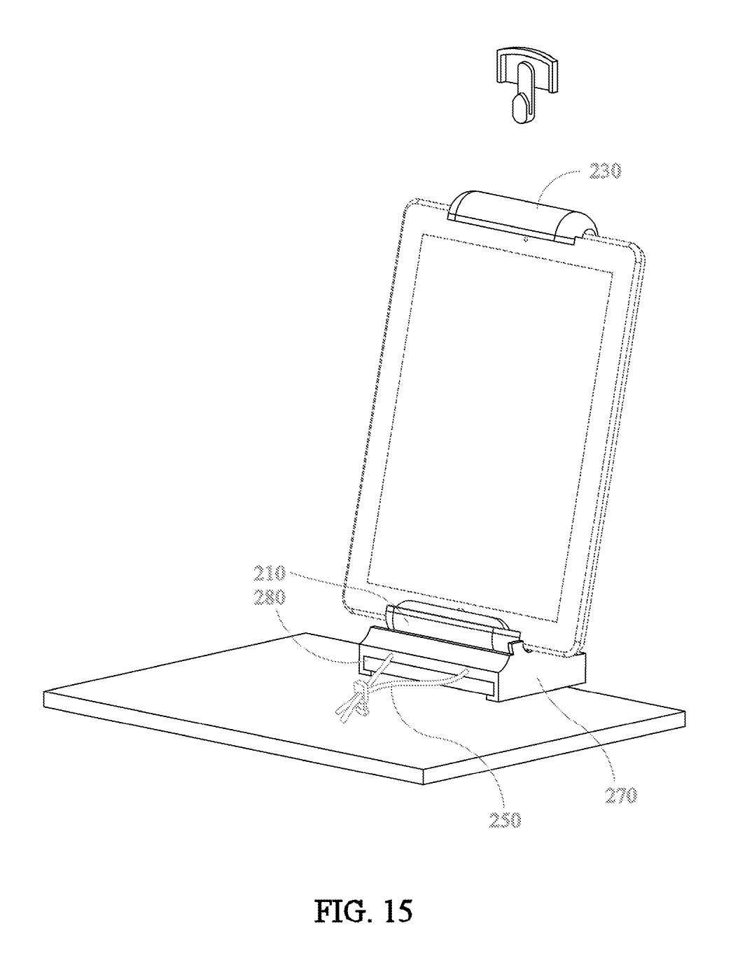

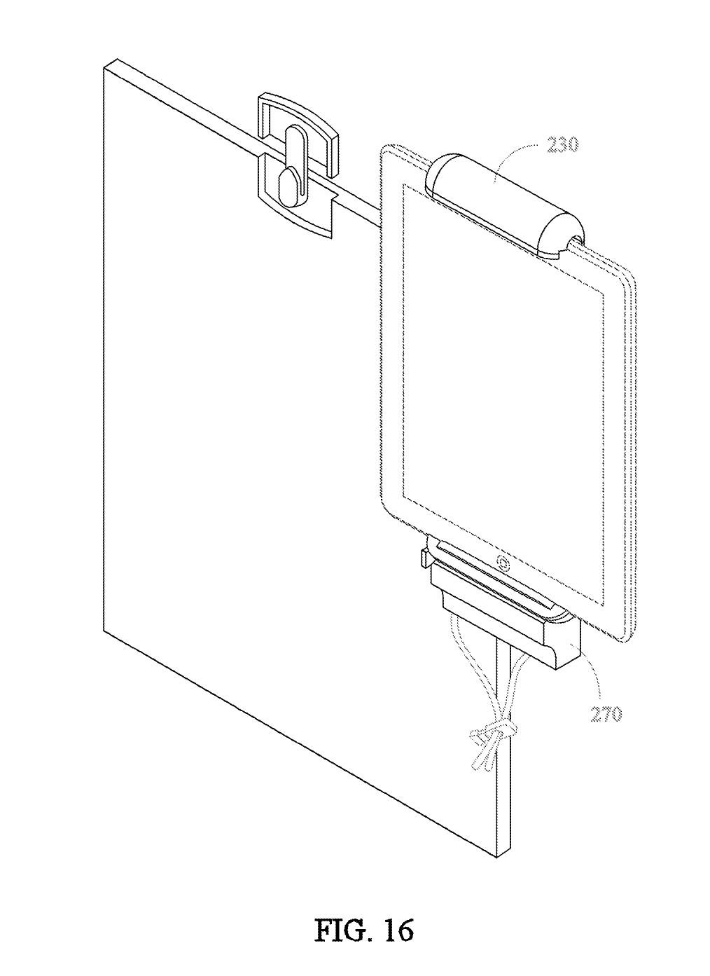

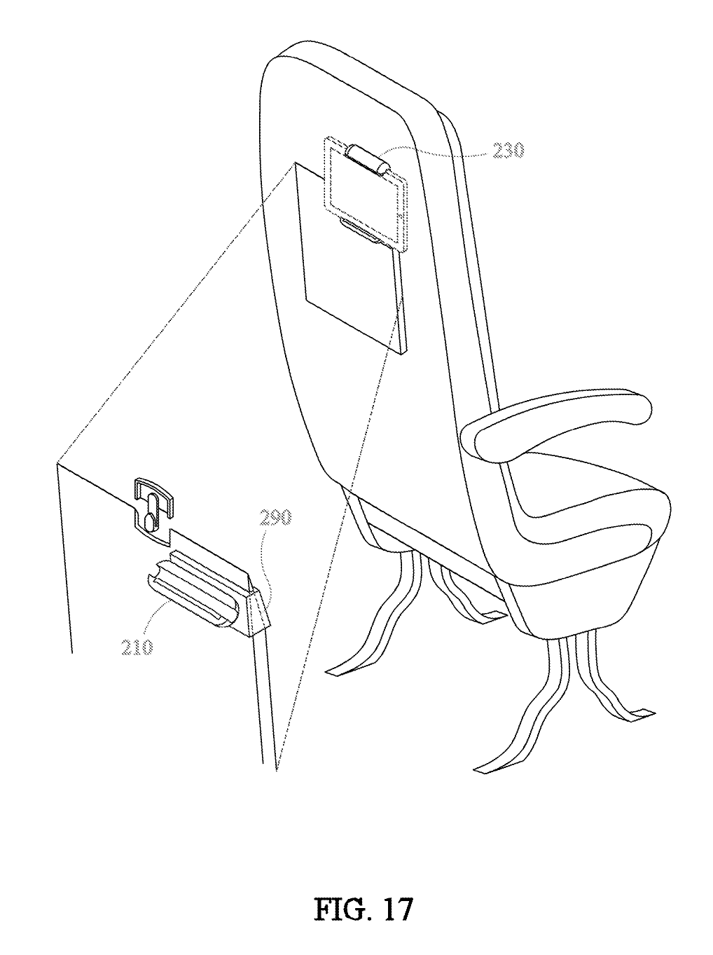

In various embodiments, a clip mounted platform 280 is provided. Ideally, the clip mounted platform 280 has a spring loaded clip which mounts the platform 280 to a tray or table, such as an airplane tray table. The clip mounted platform 280 includes a mounting element 290 such as a flat platform. The base element 260 is adapted to mount to the mounting element 290. For example, the base member 260 optionally includes a grooved track 300 adapted to receive the mounting element 290. Thus, base member 260 is adapted to mount to any number of optional mounting elements, such as clip mounted elements, stand alone elements, or other mounting elements. Such structure provides for flexibility in the way the device may be used. For example, the base member 260 may be mounted to the mounting element 290 and mounted to the back edge, or any edge, of a horizontally positioned tray-table, as shown in FIG. 15, or it may be mounted to an edge, such as a side edge, of a vertically positioned tray table as shown in FIGS. 16 and 17. In certain embodiments, as seen when viewing FIGS. 15-17, the base member 260 may be mounted to the mounting element 290 in any of various positions 90 degrees apart from one another, as seen between FIG. 15 and FIGS. 16 and 17, allowing the device to be positioned appropriately for viewing in different configurations. In certain optional embodiments, the mounting element 290 may be configured to form-fit about a tapered edge of a tray table as shown in FIG. 17.

In certain embodiments, the lower cradle member 210 includes an extension member 310 adapted to extend the groove 220 laterally. This allows for a wider support for an article.

The article holder is optionally adapted to allow an article to hang in a vertical position by hanging the lanyard 250 from a hanging element from above the upper cradle member 230. The lanyard 250 holds the lower cradle member 210 in place below the article. In other embodiments, the lower cradle member 210 and base 260 can be used to support an article from below without the need for the upper cradle member 230.

In some embodiments, the upper cradle member 230 and the lower cradle member 210 are adapted to fit together for storage or transport.

While specific embodiments have been illustrated and described, numerous modifications come to mind without significantly departing from the spirit of the invention and the scope of protection is limited by the scope of the accompanying claims.

What is claimed is:

1. An article holder for mounting an article over a base element comprising:
a mounting clip having a bottom member and a top member adapted to clip or fit onto a base element, wherein said top member comprises a top surface having a first groove therein adapted to receive an article and hold it in a viewable position.

2. The article holder for mounting an article over a base element according to claim 1, wherein the bottom member and the top member of said mounting clip are pivotally connect to one another and spring loaded with respect to one another, and wherein said mounting clip is adapted to adjust to a range of thicknesses of a base member and mount securely thereto.

3. The article holder for mounting an article over a base element according to claim 2, wherein said first groove is configured in substantially parallel alignment with a front edge of said mounting clip.

4. The article holder for mounting an article over a base element according to claim 2, further comprising a second groove in the top surface of said top member, said second groove oriented in a direction not parallel to said first groove.

5. The article holder for mounting an article over a base element according to claim 4, where said second groove is substantially perpendicular to said first groove.

6. The article holder for mounting an article over a base element according to claim 3, wherein the top surface of said top member further comprises promotional indicia thereon.

7. The article holder for mounting an article over a base element according to claim 5, wherein the top surface of said top member is adapted to receive a plate having promotional indicia thereon.

8. The article holder for mounting an article over a base element according to claim 5, wherein said mounting clip is configured in the shape of an unrelated item.

9. The article holder for mounting an article over a base element according to claim 3, wherein said mounting clip is adapted to mount to an airplane tray table, and wherein said groove is adapted to receive an electronic tablet device.

10. An article holder for mounting an article comprising:
a lower cradle member having a groove adapted to support an article at a lower edge of such an article,
an upper cradle member having a groove adapted to receive an upper edge of such an article, and
a lanyard connecting said lower cradle member and said upper cradle member.

11. The article holder for mounting an article according to claim 10, further comprising a base member, wherein said lower cradle member is adapted to be removably mounted to said base member.

12. The article holder for mounting an article according to claim 11, wherein said lower cradle member and said base member are adapted to enable said lower cradle to be adjustable between a plurality of rotation angles.

13. The article holder for mounting an article according to claim 12, wherein said base member comprises a plurality of prongs and said lower cradle member comprises receiving opening adapted to receive said prongs in a selective position to enable mounting in a plurality of selective adjustable rotation angle positions.

14. The article holder for mounting an article according to claim 11, further comprising a clip mounted platform adapted to mount to a tray or table, said clip mounted platform having a mounting element, and wherein said base member is adapted to mount to said mounting element.

15. The article holder for mounting an article according to claim 14, wherein said base member comprises a grooved track adapted to receive said mounting element.

16. The article holder for mounting an article according to claim 10, wherein said lower cradle member includes an extension member adapted to extend said groove laterally.

17. The article holder for mounting an article according to claim 10, wherein said lower cradle member is adapted to support a tablet device.

18. The article holder for mounting an article according to claim 17, wherein said lower cradle member, said upper cradle member, and said lanyard are adapted to hold such a tablet in a hanging position wherein said lower cradle member is not supported from below, and wherein said lanyard is adapted to be hung from a hanging element above said upper cradle member.

19. The article holder for mounting an article according to claim 10, wherein, in a closed mode, said upper cradle member and said lower cradle member are adapted to fit together.

20. An article holder for mounting an article comprising:
a lower cradle member having a groove adapted to support an article at a lower edge of such an article, and
a base member adapted to mount to a table or tray, wherein said lower cradle member is mountable to said base member.
